(19) United States
(12) Patent Application Publication
(10) Pub. No.: US 2002/0112108 A1
(43) Pub. Date: Aug. 15, 2002

(54) Arrangement of circuit components for interfacing to a network

(76) Inventor: Edward Shea, Lakewood, NJ (US)

Correspondence Address: KAPLAN & GILMAN , L.L.P., 900NROUTE 9 NORTH, WOODBRIDGE, NJ, 07095, US

(21) Appl. No.: 09/783,805

(22) Filed: Feb. 15, 2001

(51) Int. Cl. H01G 4/008

(52) U.S. Cl. 710/305; 361/305

(57) ABSTRACT

A novel arrangement of circuit components for interfacing the highspeed network such as an Ethernet comprises a first circuit card assembly which includes a microprocessor, a network encoding device, and a first device for performing a transformer function, and a second circuit card assembly which include a second transformer function device and a physical jack interface. Signals are conveyed over an interconnecting bus between the transformer devices, thereby eliminating or reducing interference.

### TECHNICAL FIELD

The present invention relates to network interface technologies, and more particularly, to an optimal arrangement of interface circuit components for interfacing to a network such as an Ethernet or the like.

### BACKGROUND OF THE INVENTION

Traditionally, a highspeed network (such as an Ethernet) communication port requires four circuit components as arranged in FIG. 1. A microprocessor computing device (MP) 11 interfaces to an Ethernet physical layer (PHY) 12. The PHY 12 encodes the signal in the proper format to comply with network standards (e.g., manchester encoding), the PHY connects to isolation/impedance-matching transformers (MAGS) 13 that may additionally contain common-mode chokes. The MAGS 13 connect to the output connector (JACK) 14, typically a RJ-45 style, which interfaces to the network such as an Ethernet. In general, the PHY is the network encoder, the MAGS is a transformer or functionally similar device, and the JACK is the physical network interface.

It is desired to place all these components as physically close as possible to achieve optimum results. This is not a problem if all of the components are placed on a single circuit card assembly (CCA). However, when the product is based on a distributed CCA architecture employing an interconnecting bus or backplane, the circuit designer must determine how to optimally distribute these circuit components. More specifically, as described below, when the components must be distributed among plural CCAs, it becomes challenging to determine which components should be placed on a single CCA, and which should be placed on other CCAs.

There are several possible arrangements for distributing these four circuit components on different CCAs. For example, the MP may be placed on a first CCA while the PHY-MAGS-JACK (PMJ) circuit components are mounted together on a second CCA. Such an arrangement has a drawback in that it requires the MP control and communications signals destined for the PHY to be routed through the interconnecting plane, adding to the plane's radio frequency (RF) spectrum and usurping valuable interconnection pins.

Another arrangement is to place the MP and the PHY together on a first CCA, and place the MAGS and the JACK on a second CCA. This arrangement requires the PHY to drive the MAGS via the interconnecting plane. The center tap of the MAGS attached to PHY is traditionally filtered on the CCA. The problem is that the power/ground on the MP/PHY CCA is invariably different from that on the MAGS/JACK CCA. This tends to decrease the signal-to-noise ratio, imbalance the PHY signals, and to deviate from the ideal characteristic impedance that the PHY is designed to drive.

A further arrangement is to place the MP, PHY and MAGS together on a first CCA and the JACK alone on a second CCA. This arrangement gives excellent matching of the PHY to the MAGS. However, the output of the MAGS destined for the JACK must travel through the interconnecting plane and thus leads to increased electromagnetic interference (EMI).

Therefore, there is a need for an optimal arrangement of these circuit components that does not result in the above problems.

### SUMMARY OF THE INVENTION

The novel arrangement of the present invention adopts a dual MAGS architecture to eliminate the above problems encountered in the conventional arrangements. Specifically, the arrangement of the present invention comprises a first circuit card assembly (CCA) having MP, PHY and a first MAGS embedded thereon, a second MAGS, and a JACK.

The first MAGS interfaces to the second MAGS through an interconnecting plane.

Preferably, the second MAGS and the JACK are integrated as a single commonly available hybrid device (MAG-JACK) mounted on a second CCA. The MAGS-to-MAGS signals that transverse the interconnecting plane are floating, balanced and isolated, carrying no DC currents between CCAs. This allows the signals to translate from the first CCA to the second without creating any DC current loops or associated mixed ground phenomena, while minimizing differential EMI and maximizing common mode EMI. The common mode EMI is then eliminated by the common mode choke incorporated between the second MAGS and the JACK.

### BRIEF DESCRIPTION OF THE DRAWINGS

The above and other features and advantages of the arrangement of the present invention will be clearer upon reading the detailed description of the preferred embodiments with reference to the accompanying drawings, in which:

FIG. 1 is a block diagram showing an arrangement of the circuit components in the prior art;

FIG. 2 is a block diagram conceptually showing an arrangement of the dual MAGS architecture of the present invention;

FIG. 3 schematically shows the arrangement in FIG. 2 implemented on two circuit card assemblies in which the second MAGS and the JACK is a single commonly available hybrid device;

FIG. 4 shows another embodiment of the arrangement of the invention in which a single MP on the first CCA controls plural PHYs and MAGSs;

FIG. 5 shows a third embodiment of the arrangement of the invention in which the second MAGS and the JACK are discrete parts.

### DETAILED DESCRIPTION OF THE PREFERRED EMBODIMENT

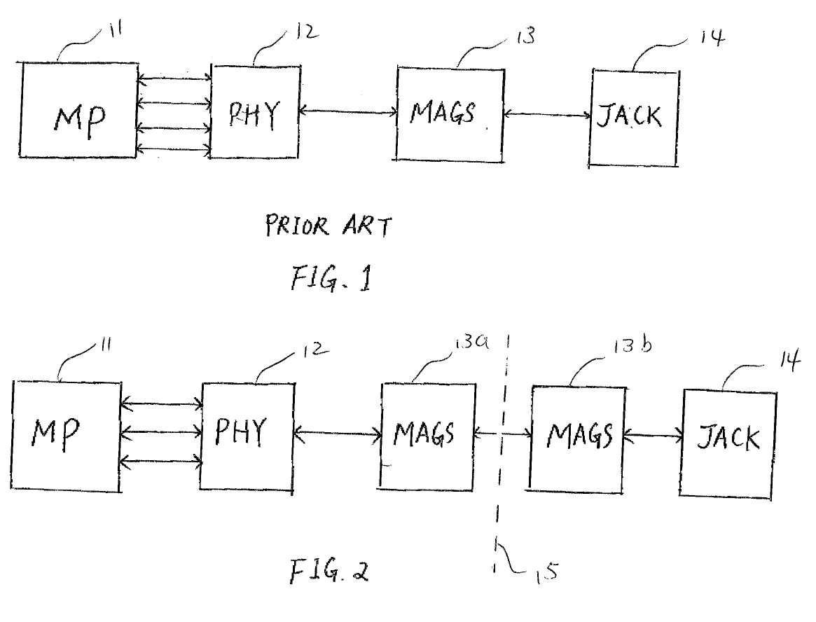

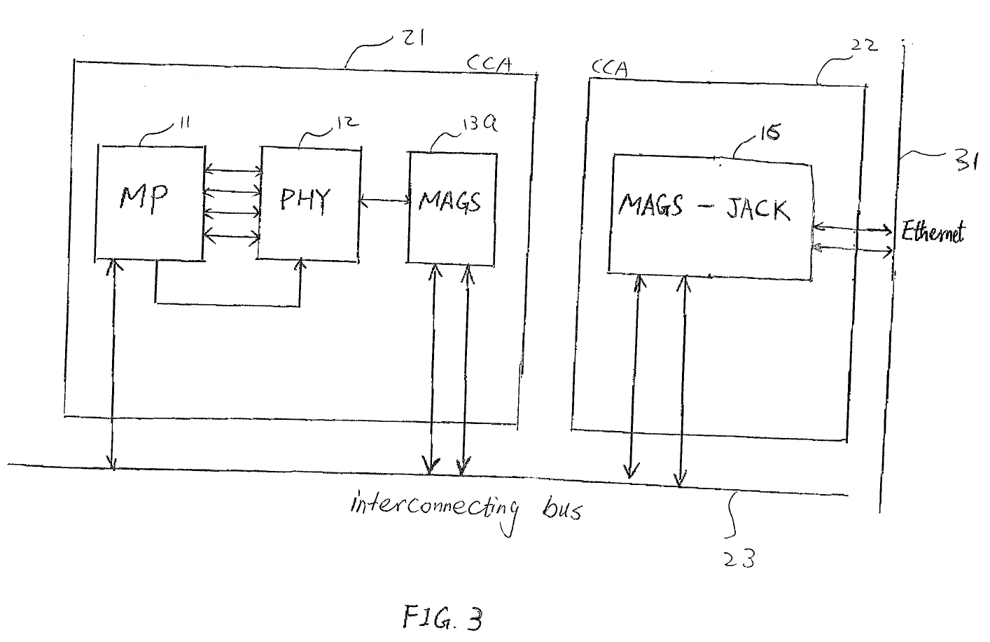

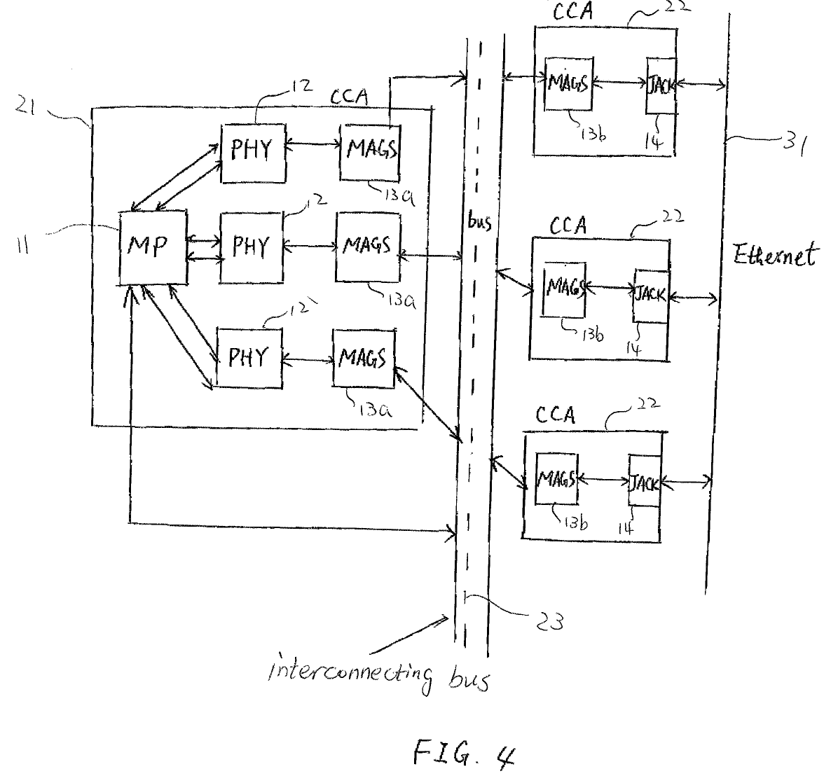

Reference is made to FIGS. 2 and 3 which shows an exemplary embodiment of the novel arrangement of the present invention. A dual MAGS architecture is employed in the invention. In particular, there are two separate CCAs 21 and 22. The MP 11, PHY 12 and a first MAGS 13a are mounted on the first CCA 21, and a second MAGS and the JACK are integrated as a single commonly available hybrid device 15 on the second CCA 22. The first MAGS 13a interfaces to the second MAGS of the hybrid device 16 over an interconnecting plane 15 which is implemented as an interconnecting bus 23 in FIG. 3. The output of the first MAGS 13a on the first CCA 21 is routed through the interconnecting plane 15 to the second MAGS on the second CCA 22, and finally to an Ethernet network 31 through the JACK on the second CCA 22.

The input center tap on the second MAGS is connected to local ground on CCA 22, thus locking down the (otherwise floating) MAGS-to-MAGS signals allows them to translate from the electrical environment on CCA 21 to the electrical environment on CCA 22. This also has the advantage of balancing the differential pairs of the MAGS about the local ground on CCA 22.

The output of the second MAGS on the second CCA 22 may preferably contain dual common-mode chokes. This eliminates any common-mode EMI noise that the MAGS-to-MAGS signals may have picked up as they traverse the interconnecting plane 15.

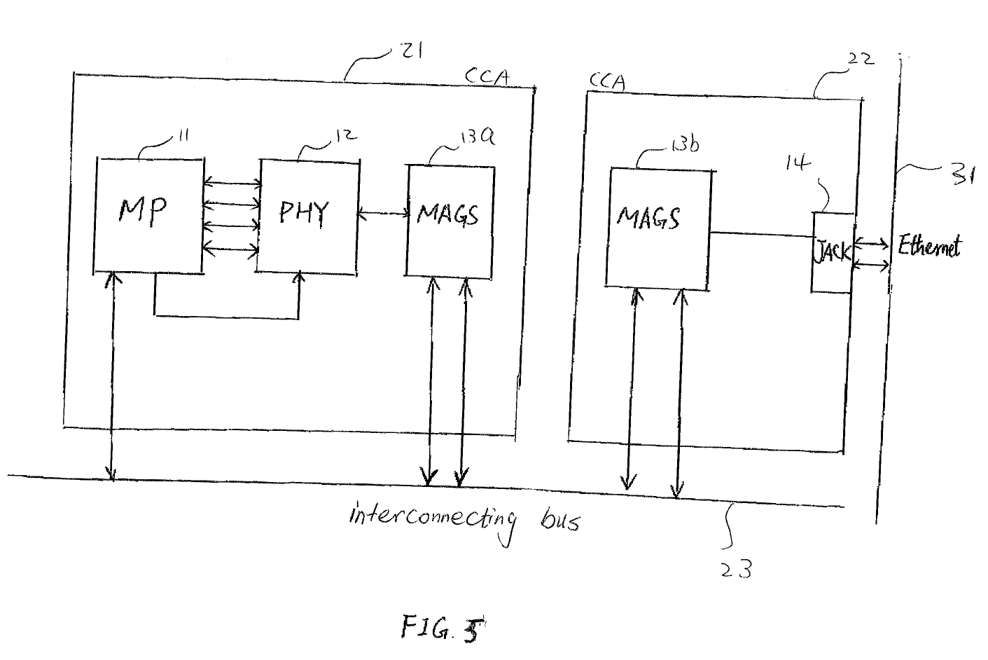

FIG. 4 shows another embodiment where the first CCA 21 in which a signal MP controls plural sets of PHYs and MAGSs. The first CCA 21 interfaces to a plurality of the second CCAs 22 through an interconnecting bus 23. In particular, each first MAGS 13a interfaces to one second MAGS 13b on one of the second CCAs 22. Each second CCA 22 is connected to the Ethernet 31 through a JACK 14 on each CCA 22.

Even though the above has described in detail, preferred embodiments of the invention, it is understood that numerous changes, variations and modifications are apparent to the person skilled in the art without departing from the spirit of the invention. For example, unlike the hybrid device 16, the second MAGS 13b and the JACK 14 may be discrete parts as shown in FIG. 5. Therefore, the scope of the invention is solely intent to be limited by the accompanying claims.

What is claimed is:

1. An arrangement for interfacing to a network, comprising:
a first circuit card assembly having MP, PHY and a first MAGS embedded thereon in series;
a second MAGS;
a JACK for output to said network and being connected to said second MAGS; and
wherein said first MAGS interfaces to said second MAGS through an interconnecting plane.

2. The arrangement of claim 1 wherein said second MAGS and said JACK are both embedded in a single device.

3. The arrangement of claim 1 wherein said second MAGS and said JACK are discrete parts.

4. The arrangement of claim 1 wherein an input of said second MAGS is connected to a local ground.

5. The arrangement of claim 1 wherein an output of said second MAGS comprises dual common-mode chokes.

6. The arrangement of claim 1 wherein said first and second MAGs communicate to each other over an interconnecting bus.

7. The arrangement of claim 1 wherein said network is an Ethernet network.

8. An arrangement for interfacing a network, comprising:
a first circuit card assembly comprising a MP, a plurality of PHYs each connected to said MP, and a plurality of first MAGSs connected to each of said PHYs respectively;
a plurality of second circuit cards each of which comprises a second MAGS and a JACK for interfacing to said network; and
wherein said each of said first MAGSs interfaces to said second MAGS on one of said second circuit cards through an interconnecting plane.

9. The arrangement of claim 8 wherein said second MAGS is connected to a local ground.

10. The arrangement of claim 8 wherein said second MAGS comprises dual common-mode chokes.

11. A circuit card, comprising:
an MP,
at least one PHY; and
at least one MAGS connected to said PHY; and
wherein said MP, PHY and MAGS are all embedded together on a single circuit card, and wherein said circuit card communicates with a network via a second circuit card.

12. The integrated circuit card of claim 11 wherein said MAGS is adapted to interface to a second set of MAGS that is not located on said circuit card.

13. The integrated circuit card of claim 12 wherein said MAGS and said second set of MAGS communicate through an interconnecting bus.

14. The integrated circuit card of claim 11 wherein said second set of MAGS is embedded with a JACK for interfacing to a network.

15.The integrated circuit card of claim 14 wherein said network is an Ethernet network.

16. Apparatus comprising a network and a microprocessor for communicating with said network, and a communications path from said microprocessor to said network, the communications path including a first and second set of MAGS.

17. The apparatus of claim 16 wherein said first and second set of MAGS is are located on different CCAs.

18. The apparatus of claim 17 wherein said second of MAGS is connected to a local ground.
